(19) United States
(12) Patent Application Publication
(10) Pub. No.: US 2009/0034959 A1
(43) Pub. Date: Feb. 5, 2009

(54) FLASH-CONTROL CIRCUIT AND IMAGE CAPTURING MODULE USING THE SAME

(75) Inventor: PEI-CHONG TANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/137,516

(22) Filed: Jun. 11, 2008

(30) Foreign Application Priority Data
Aug. 2, 2007 (CN) 200710201259.2

(51) Int. Cl. G03B 7/26

(52) U.S. Cl. 396/205

(57) ABSTRACT

A flash-control circuit is designed for providing a high current to a load. The flash-control circuit includes an operational amplifier, a MOSFET, and a discharge power source. The operational amplifier is for receiving a pulse signal and outputting a high level voltage when the pulse signal is high. The MOSFET acts as a switch for delivering a high current to the load. The discharge power source is for providing the high current. The electrical current flows through the load, the MOSFET, then to ground when the MOSFET is on. An image capturing module using the flash-control circuit is also provided.

### BACKGROUND

1. Force of the Invention

The present invention generally relates to image capturing modules, and particularly relates to an image capturing module using a flash-control circuit.

2. Description of Related Art

Image capturing modules such as cameras are widely used. Referring to FIG. 4, a conventional camera 10, for taking images of an object 999, is illustrated. The camera 10 includes a controller 12, a flash-control circuit 14, a light-emitting diode (LED) 16, a shutter 17, and an optical sensor 18. In operation, the controller 12 sends illumination signals to the flash-control circuit 14. The flash-control circuit 14 drives the LED 16 to emit light based on the illumination signals. When the shutter 17 is opened, the optical sensor 18 is exposed to light reflected from the object 999. The controller 12 controls the optical sensor 18 to receive the reflected light from the object 999. The optical sensor 18 converts the reflected light to electrical signals. The electrical signals are sent to subsequent circuits (not shown) to be processed to obtain a digital image of the object 999.

Referring to FIG. 5, the camera 10 utilizes a conventional exposure method that has a comparative long exposure time. In detail, the flash-control circuit 14 provides current to the LED 16, the range of the current may be from 0- to 20 milliamps (mA) in a normal situation, while the exposure time of the shutter 17 may be preset for less than 1 millisecond (ms). Typically, a maximum of 20 mA of current flows through the LED 16. Because of the low current and short exposure time, the quality of an image captured in this manner is poor. To increase the quality of the image, it is necessary to increase the current, thereby increasing the brightness of the LED, and/or increase the exposure time. However, it may not be possible to increase the current to sufficiently increase the brightness of the LED, so even if the exposure time is increased, clear images of moving objects are difficult to capture.

Therefore, improvements for increasing the current of an image capturing module are needed in the industry to address the aforementioned deficiency.

### SUMMARY

A flash-control circuit for providing a high current to a load. The flash-control circuit includes an operational amplifier, a MOSFET, and a discharge power source. The operational amplifier is for receiving a pulse signal and outputting a high level voltage when the pulse signal is high. The MOSFET acts as a switch for delivering a high current to the load. The discharge power source is for providing the high current. The electrical current flows through the load, the MOSFET, then to ground when the MOSFET is on. An image capturing module using the flash-control circuit is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is an block diagram showing an image capturing module in accordance with an exemplary embodiment.

FIG. 2 is circuit diagram showing a flash-control circuit for the image capturing module of FIG. 1.

FIG. 3 is a waveform chart showing a current generated by the flash circuit of FIG. 2.

FIG. 4 is an block diagram showing a conventional camera including a flash-control circuit.

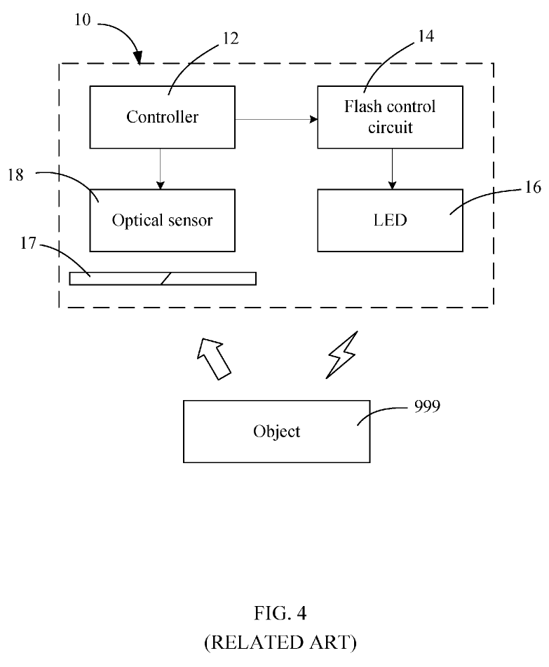

FIG. 5 is a waveform chart showing an current generated by the flash-control circuit of FIG. 4.

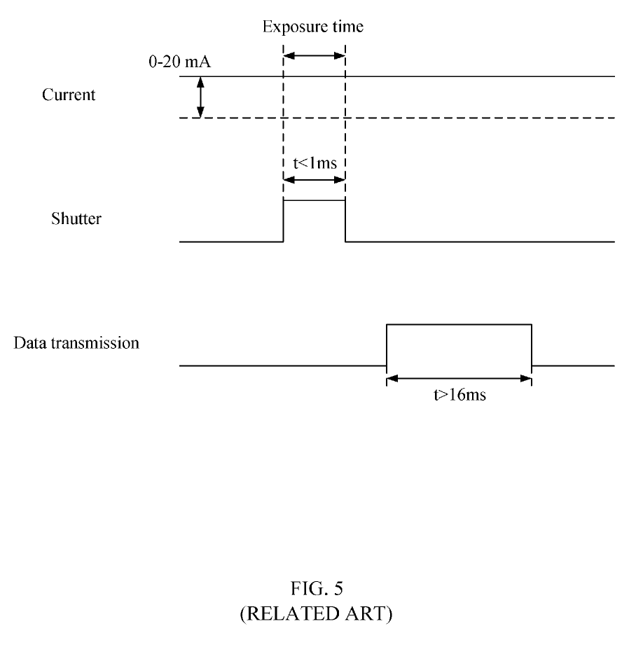

### DETAILED DESCRIPTION OF THE EMBODIMENTS

Reference will now be made to the drawings to describe an exemplary embodiment of the present flash-control circuit, and an exemplary embodiment of the present image capturing module.

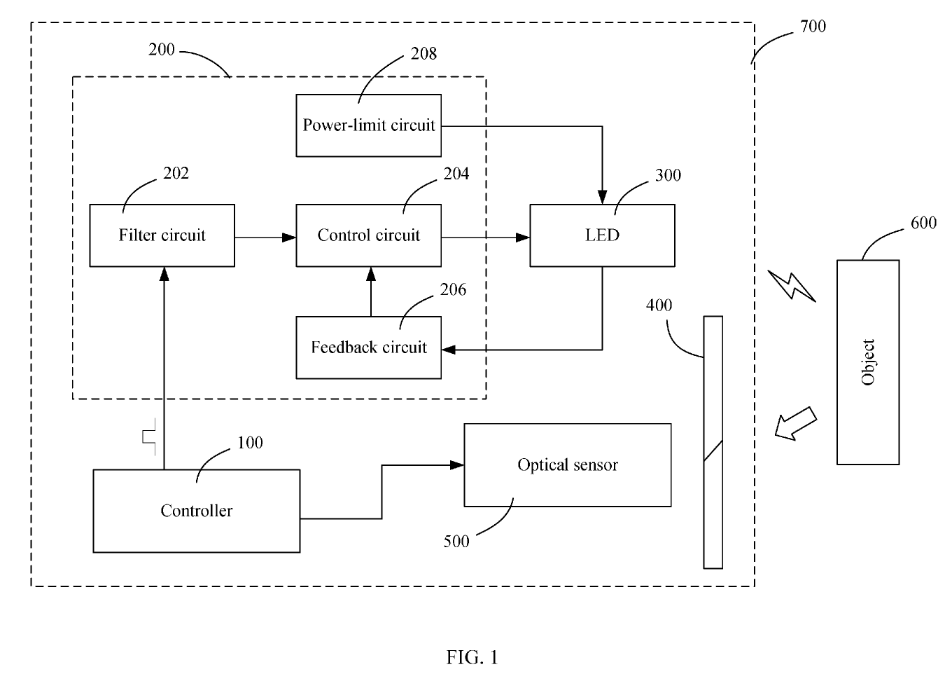

FIG. 1 shows a block diagram of an image capturing module 700 in accordance with an exemplary embodiment. The image capturing module 700 is for taking images of an object 600. The image capturing module 700 includes a controller 100, a flash-control circuit 200, a light-emitting diode (LED) 300, a shutter 400, and an optical sensor 500. The controller 100 sends a pulse signal to the flash-control circuit 200. The flash-control circuit 200 provides a high current that drives the LED 300 to emit light based on the pulse signal. The shutter 400 is configured to open and allow reflected light from the object 600 to enter and be captured by the optical sensor 500 over an exposure time. The controller 100 controls the optical sensor 500 to receive the reflected light from the object 600. The optical sensor 500 converts the reflected light to electrical signals. The electrical signals are sent to subsequent circuits (not shown) for processing, thereby yielding a digital image of the object 600.

The flash-control circuit 200 includes a filter circuit 202, a control circuit 204, a feedback circuit 206, and a power-limit circuit 208. The filter circuit 202 is for filtering out noise from the pulse signal. The control circuit 204 is for generating the high current during an interval of the pulse signal. The high current has a sufficient value such as 200 milliamps (mA) that is greater than a normal maximum value that is 20 mA. The feedback circuit 206 is for providing a feedback signal to the control circuit 204 and signaling the control circuit 204 to stop generating the high current when the pulse signal is low. The power-limit circuit 208 is for limiting the high current with the sufficient value (200 mA, see above) during an effective duration. In detail, the high current drops from the sufficient value to a normal value in the effective duration.

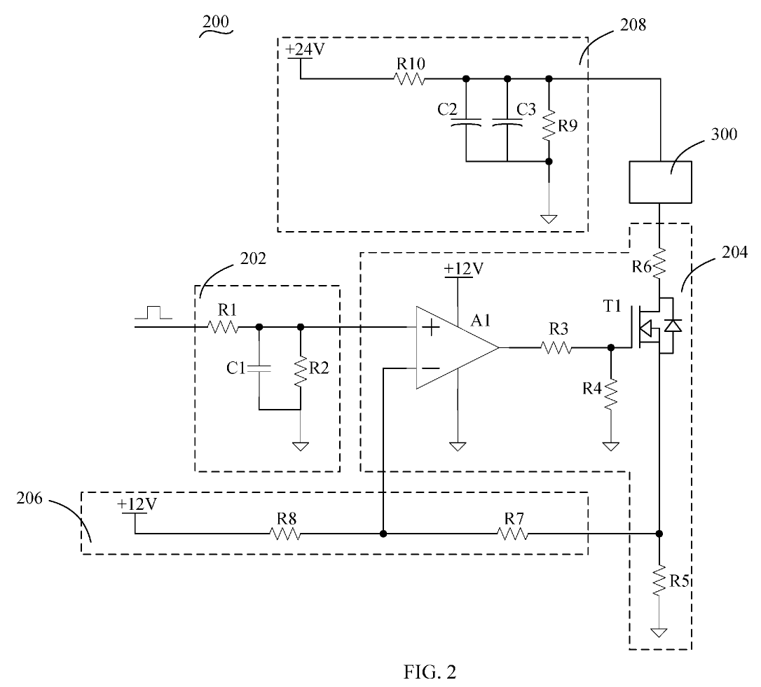

Referring to FIG. 2, a circuit diagram of the flash-control circuit 200 is illustrated. The filter circuit 202 includes two resistors R1, R2, and a capacitor C1. A first end of the resistor R1 is for receiving the pulse signal, and a second end of the resistor R1 is coupled to the control circuit 204. The capacitor C1 and the resistor R2 are correspondingly connected between the second end of the resistor R1 and ground. Here, the capacitor C1 and the resistor R2 are used to filter out noise from the pulse signal.

The control circuit 204 includes an operational amplifier A1, a metallic oxide semiconductor field effect transistor (MOSFET) T1, and resistors R3, R4, R5, R6. The operational amplifier A1 works at +12 volts (V). The non-inverting input of the operational amplifier A1 is coupled to the second end of the resistor R1, and the inverting input of the operational amplifier A1 is coupled to the feedback circuit 206. The output of the operational amplifier A1 is coupled to a first end of the resistor R3. A second end of the resistor R3 is coupled to the gate of the MOSFET T1, and the gate of the MOSFET T1 is coupled to ground via the resistor R4. The source of the MOSFET T1 is coupled to ground via the resistor R5, and is also coupled to the feedback circuit 206. The drain of the MOSFET T1 is coupled to the LED 300 via the resistor R6.

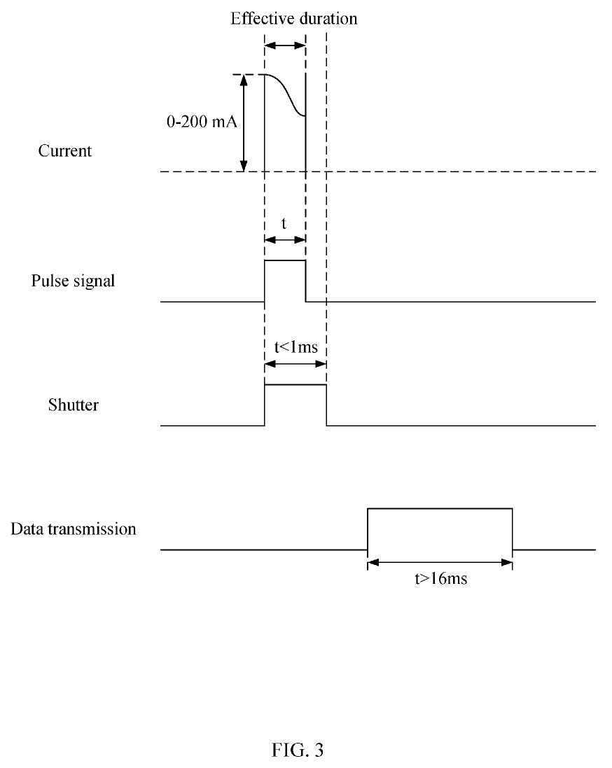

The non-inverting input of the operational amplifier A1 receives the pulse signal, and the output of the operational amplifier A1 outputs a high level voltage when the pulse signal is high. The MOSFET T1 turns on after receiving the high level voltage, and the high current with the sufficient value (200 mA) is generated. The high current flows through the LED 300. Referring to FIG. 3, in an effective duration during which the pulse signal is high, the high current drops from 200 mA to 100 mA. During the effective duration, no matter what the electrical current is, 200 mA or 100 mA, the sufficient value of the electrical current is far greater than the normal maximum value that is 20 mA. The effective duration is shorter than an exposure time of the shutter 400. Therefore, the optical sensor 500 receives the reflected light with sufficient intensity without increasing the exposure time.

The feedback circuit 206 includes resistors R7, R8. A first end of the resistor R7 is coupled to the source of the MOSFET T1, and a second end of the resistor R7 is coupled to the inverting input of the operational amplifier A1, and is also coupled to a first end of the resistor R8. A second end of the resistor R8 is coupled to a +12V voltage source. The resistor R7 works as a feedback resistor and transmits the feedback signal to the inverting input of the operational amplifier A1.

In addition, when the pulse signal is low, the actual value of the pulse signal is not 0, thus the operational amplifier A1 still outputs noise signals interrupting successive circuits. In this circumstance, in order to ensure that the operational amplifier A1 outputs 0, it is necessary to supply an assistant voltage to the inverting input of the operational amplifier A1, wherein the assistant voltage is higher than the low level of the pulse signal. In the embodiment, the resistors R8, R7, R5 are serially coupled between the +12V voltage source and ground, so that the assistant voltage is generated from an interconnection between the resistor R7 and the resistor R8. In other words, the +12V voltage source and the resistor R8 combine together as a power source for supplying the assistant voltage.

The power-limit circuit 208 includes resistors R9, R10, and capacitors C2, C3. A first end of the resistor R10 is coupled to a +24V voltage source, and a second end of the resistor R10 is coupled to the LED 300. The capacitors C2, C3, and the resistor R9 are coupled parallelly between the second end of the resistor R10 and ground. Here, the resistor R10 has a high resistance value.

When the pulse signal is high, the LED 300 works in an overload state. If the overload state lasts too long, the LED 300 will be damaged. Therefore, in operation, the capacitors C2, C3 are charged by the +24V voltage source first, and then are discharged to generate the high current with the sufficient value. Because a discharge operation of the capacitors C2, C3 is very fast, the high current rapidly drops from the sufficient value to the normal value.

After the discharge operation, the +24 voltage source supplies power to the LED 300 via the resistor R10. Because the resistor R10 has a high resistance value, a value of the electrical current of the LED 300 is limited under the normal maximum value that is 20 mA. Here, the power-limit circuit 208 and the +24V voltage source combines together as a discharge power source.

When the flash-control circuit 200 operates, the filter circuit 202 filters out the noise from the pulse signal, and then the pulse signal is transmitted to the non-inverting input of the operational amplifier A1. The operational amplifier A1 transmits the high level voltage to the gate of the MOSFET T1 when the pulse signal is high, and the MOSFET T1 turns on. The capacitors C2, C3 simultaneously discharges to provide the high current to the LED 300, and the resistor R7 transmits the feedback signal to the inverting input of the operational amplifier A1 to stabilize the operational amplifier A1. When the pulse signal is low, the assistant voltage is received by the inverting input of the operational amplifier A1, and the operational amplifier A1 stops outputting the high level voltage. The MOSFET T1 turns off, and the LED 300 stops working.

As described above, the flash-control circuit 200 utilizes the control circuit 204 to receive the pulse signal, and then to generate the high current having the sufficient value. The sufficient value is greater than the normal maximum value that is 20 mA. Therefore, the LED 300 can emit very bright light based on the high current. Furthermore, the power-limit circuit 208 is also used to protect the LED 300 from being damaged. If the pulse signal stays high for an extended period, the power-limit circuit 208 can adjust the high current from the sufficient value to the normal value rapidly. In another embodiment, the LED 300 can be other loads, such as a LED array, a laser diode, or a lamp.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A flash-control circuit comprising:
an operational amplifier for receiving a pulse signal and outputting a high level voltage when the pulse signal is high;
a MOSFET for receiving the high level voltage and to be turned on by the high level voltage and for delivering a high current with a sufficient value to a load; and
a discharge power source coupled to ground via the MOSFET;
wherein, when the MOSFET is on, the high current is supplied from the discharge power source in a discharge operation, and flows through the load, through the MOSFET, to ground, and the sufficient value is greater than a normal maximum value.

2. The flash-control circuit according to claim 1, wherein the discharge power source comprises a power source and a capacitor, and the capacitor is coupled between an output of the power source and ground, and the output of the power source is coupled to the drain of the MOSFET via the load.

3. The flash-control circuit according to claim 2, wherein the discharge power source comprises a first resistor coupled between the output of the power source and ground.

4. The flash-control circuit according to claim 3, wherein the discharge power source comprises a second resistor coupled between the output of the power source and a common connection node of the capacitor, the first resistor and the load.

5. The flash-control circuit according to claim 2, wherein the power source is a +24V power source.

6. The flash-control circuit according to claim 1, wherein a resistor is coupled between the output of the operational amplifier and the gate of the MOSFET.

7. The flash-control circuit according to claim 1, wherein a resistor is coupled between the gate of the MOSFET and ground.

8. The flash-control circuit according to claim 1, wherein a resistor is coupled between the source of the MOSFET and ground.

9. The flash-control circuit according to claim 1, further comprising a feedback circuit coupled between the source of the MOSFET and the inverting input of the operational amplifier.

10. The flash-control circuit according to claim 9, wherein the feedback circuit comprises a first resistor coupled between the source and the inverting input of the operational amplifier.

11. The flash-control circuit according to claim 10, wherein the feedback circuit comprises a power source and a second resistor coupling the power source to the inverting input of the operational amplifier.

12. The flash-control circuit according to claim 11, wherein the power source is a +12V power source.

13. The flash-control circuit according to claim 1, further comprising a filter circuit for filtering out noise from the impulse signal.

14. The flash-control circuit according to claim 1, wherein the filter circuit comprises a first resistor coupled to the non-inverting input of the operational amplifier for receiving the pulse signal.

15. The flash-control circuit according to claim 13, wherein the filter circuit comprises a capacitor and a second resistor, the capacitor and the second resistor are respectively coupled between ground and an interconnection between the first resistor and the non-inverting input.

16. An image capturing module comprising:
a controller for sending a pulse signal;
a light emitting diode for emitting light; and
a flash-control circuit for receiving the pulse signal and providing a high current with a sufficient value to the light emitting diode, the flash-control circuit comprising:
an operational amplifier coupled to the controller via the non-inverting input, the operational amplifier having an output and an inverting input;
a MOSFET coupled to the output of the operational amplifier via the gate, and coupled to ground via the source and a first resistor and coupled to the inverting input via the source and a second resistor, and coupled to the light emitting diode via the drain; and
a discharge power source comprising a first power source coupled to the light emitting diode and a capacitor coupled between ground and an interconnection between the power source and the light emitting diode.

17. The image capturing module according to claim 16, further comprising a shutter for being opened to allow the light coming therethrough.

18. The image capturing module according to claim 16, further comprising an optical sensor coupled to the controller, and the optical sensor is used for receiving reflected light from an object and generating electrical signals by demodulating the reflected light.

19. The image capturing module according to claim 16, wherein the flash-control circuit comprises a second power source coupled to the inverting input via a third resistor.

20. The image capturing module according to claim 16, wherein the flash-control circuit comprises a third resistor coupled to the non-inverting input of the operational amplifier, a capacitor coupled between ground and an interconnection between the third resistor and the non-inverting input of the operational amplifier, and a fourth resistor coupled between ground and an interconnection between the third resistor and non-inverting input of the operational amplifier.
